(19) United States
(12) Patent Application Publication
(10) Pub. No.: US 2004/0028124 A1
(43) Pub. Date: Feb. 12, 2004

(54) Method of operating a communications system and a communications system

(76) Inventors: Jukka Nuutinen, Oulu (FI); Kari Horneman, Oulu (FI)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/207,144

(22) Filed: Jul. 30, 2002

(51) Int. Cl. H04B 17/00

(52) U.S. Cl. 375/227

(57) ABSTRACT

The invention is a method of estimating signal power in a spread-spectrum communications system whist interference is being caused by another communications system, such as a GSM system. The method comprises the steps of:

receiving a signal;

dividing the signal into a plurality of subsets of signal samples;

processing the signal samples of a subset based on the assumption that the subset has a Gaussian distribution; and

removing or replacing signal samples which do not correspond to the Gaussian distribution in order to reduce the interference.

This invention relates to a method of operating a communications system and a communications system. It is particularly, but not exclusively, related to estimating signal power in a communications system, such as a spread-spectrum communications system, operating in the presence of interference caused by a discontinuous interference source.

Second generation (2G) mobile communications systems are well known. An example of such a system is the Global System for Mobile communications (GSM) system. It is a circuit-switched digital system. Other 2G systems are the Personal Digital Cellular (PDC) system in Japan, TDMA (IS-136), and CDMA (IS-95-B). These systems have higher capacity and lower power requirements and provide better voice quality than previous analogue systems. 2G systems also provide simple data services, such as the short message service (SMS) in GSM which enables the sending of short text messages to and from mobile telephones.

As demand for data services has grown, 2G systems have been developed into systems providing enhanced data services. Examples of such systems are the general packet radio service (GPRS) and high-speed circuit-switched data (HSCSD). GPRS is a packet-switched system. Since these systems are an enhancement of 2G systems, they are sometimes referred to as 2.5G systems. For the sake of simplicity, in the following description, the term 2G will be used to refer both to 2G and 2.5G systems.

Third generation (3G) systems have been developed to provide improved services compared to the currently available and used 2G systems. 3G systems are based on either code division multiple access (CDMA) and on time domain multiple access (TDMA). Examples of CDMA systems are UMTS (Universal Mobile Telecommuncations System) and CDMA2000. UMTS is based on wide-band code division multiple access (WCDMA).

Since 3G systems are complex and costly to set up, their roll-out will be gradual. Therefore, it is intended that in some locations, 2G systems will continue to operate even after 3G systems have been set up and are operating.

Taking the European version of GSM as an example of a 2G system, in each of the 900 MHz and 1.8 GHz frequency bands it uses a pair of 25 MHz wide bands in respective uplink (from mobile telephones to the network) and downlink (from the network to mobile telephones) directions. The 25 MHz bands are divided up into separate frequency slots spaced by 200 kHz to provide frequency domain multiple access (FDMA). Each 200 kHz channel is divided into eight time slots to provide TDMA. Taking CDMA as an example of a 3G system, user information bits are spread over a relatively wide bandwidth by being multiplied by CDMA spreading codes. In the case of WCDMA, the user information bits are multiplied by quasi-random bits (called chips).

Problems can be caused by the different ways in which 2G systems and 3G systems use the spectrum over which they operate. Some of the 2G systems, such as GSM, are ‘bursty’ producing relatively short high discontinuous power transmissions. 3G systems which use CDMA spreading codes to spread data over a relatively wide bandwidth aim to have a substantially constant power level across their frequency range of operation. If a 2G system produces ‘bursty’ transmissions within the frequency range across which a 3G system spreads its data, this is likely to be perceived by the 3G system as relatively high power interference.

This interference can cause a particular problem in relation to load control in such 3G systems. In general, load control defines how much load is in a particular cell. Load control can be done in a number of ways. One approach is based on the number of bits which go through a link. Another approach is based on the received power.

In this latter approach, in downlink (in which a base station transmits and a mobile station receives) load control is based on the measurement of the transmitted power and in uplink (in which the mobile station transmits and the base station receives) the load control is based on power measurement. Uplink load control is part of a control procedure referred to as admission control which is used to control whether a subscriber is allowed access to a network. It is useful to control this in interference limited systems such as CDMA systems. If there is relatively high power interference in a received signal, power measurement of the received signal can indicate an erroneously high load. As a result, when such interference is present, admission control may unnecessarily restrict the amount of load or traffic that is sent on an uplink channel.

Generally, in normal conditions (moderate signal strength and additive wide Gaussian noise (AWGN)), it is a fair approximation that a received signal has a Gaussian distribution. If the signal is raised to the power of two, the distribution is χ² (Chi square), that is, the square of a Gaussian distribution is Chi square. The envelope of the squared values of a Gaussian distribution is Rayleigh.

Classically, in WCDMA systems, variance of the received signal is used as a basis to estimate interference in a received signal. This is based on the assumption that the received signal (including interference) can be approximated to a Gaussian distribution. If it has a non-Gaussian distribution, variance is not such a good basis on which to estimate the interference In a case in which a 2G system such as a GSM system is working in the vicinity of a WCDMA system, that is GSM transmissions are interfering with reception by WCDMA base transceiver stations, this causes a received signal to have a non-Gaussian distribution. If the received signal contains strong localised values, for example strong bursty interference, the tails of the distribution start to rise and this changes the distribution so that it becomes less Gaussian. In this case, the variance moves away from what should be its true value in the absence of interference and does not provide the basis of such a good interference estimate.

Interference in a set of power sample values can be generally estimated by the equation:

E((x−μ)^{α}) (1)

where E is operator expectation value, x is the received sample vector, μ is the mean value of the samples, and α is a rational or irrational number (0<α≦2) Such a distribution is said to be alpha-stable. In the case of a Gaussian distribution, that is when GSM interference is not present, α is equal to 2. This demonstrates why dealing with a received signal having a Gaussian distribution is straightforward, for such a distribution the statistics of the received signal are already known and do not need to be determined.

According to a first aspect of the invention we provide a method of operating a communications system comprising:

receiving a signal;

processing the signal based on the assumption that it has a particular statistical distribution; and

removing parts of the signal which do not correspond to the particular statistical distribution.

The method may comprise estimating signal power. It may comprise estimating noise and/or interference level. In one embodiment, the invention is concerned with reducing the interference component in a received signal comprising a noise component and an interference component.

The method may be for reducing interference caused in a spread-spectrum communication system by a non-spread-spectrum communication system, for example a TDMA system.

The method may have the assumption that the signal has a Gaussian statistical distribution. The method may involve removing parts of the signal which do not correspond to a Gaussian statistical distribution.

The method may comprise estimating signal power when bursty interference is present in the signal. By ‘bursty’ is meant discontinuous interference. It may be of short duration. Such interference may have a relatively high power compared to the power of the signal.

The signal may be divided into subsets comprising sets of sample values, Such a division may lead to a sequence of sample values in the time domain. The method may involve calculating the mean of the set of sample values for at least one of the subsets. The method may involve calculating the median of the set of samples for at least one of the subsets. The subsets may be assessed to determine if they are corrupted, that is if they contain more than a particular level of interference. The subsets may be assessed to determine if they are uncorrupted, that is if they contain less than a predetermined level of interference. The predetermined level of interference may be set by indicating as uncorrupted those subsets having a difference between the median and mean of the sample values in the subset which is less than a predetermined or threshold value.

For a subset assessed as being corrupted, it may be adjusted by removing one or more of the sample values from the subset. The removed sample values may be those which have values exceeding a statistical defined threshold, for example the the median value of the sample values of the subset. Alternatively, for a subset assessed as being corrupted, it may be adjusted by replacing certain of the sample values from the subset.

In one embodiment, the invention provides a way of reducing GSM interference contribution from a received WCDMA signal (including noise). Reducing such interference may enable more accurate estimation of received power whenever interference is present.

The method may relate to load control. It may relate to admission control. It may relate to estimation of received power level whilst GSM interference is present.

The method may be used in a wireless communications system. The method may be used in a spread-spectrum communications system. The method may be used in a CDMA system such as a WCDMA system. The invention may be implemented in a network, in a mobile terminal, or in both.

According to a second aspect of the invention there is provided a network element comprising:

means for receiving a signal;

means for processing the signal based on the assumption that it has a particular statistical distribution; and

means for removing parts of the signal which do not correspond to the particular statistical distribution.

The network element may be an admission or a load control unit. It may be a radio network controller (RNC), a node B, a base station, or a base transceiver station.

According to a third aspect of the invention there is provided a communications system comprising:

means for receiving a signal;

means for processing the signal based on the assumption that it has a particular statistical distribution; and

means for removing parts of the signal which do not correspond to the particular statistical distribution.

The communications system may be a CDMA system. It may be a WCDMA system.

According to a third aspect of the invention there is provided a communications terminal comprising:

means for receiving a signal;

means for processing the signal based on the assumption that it has a particular statistical distribution; and

means for removing parts of the signal which do not correspond to the particular statistical distribution.

The communications terminal may be a CDMA terminal. It may be a WCDMA terminal.

In a preferred embodiment, the invention relates to load and/or admission control.

The invention will now be described, by way of example only, with reference to the accompanying drawings in which:

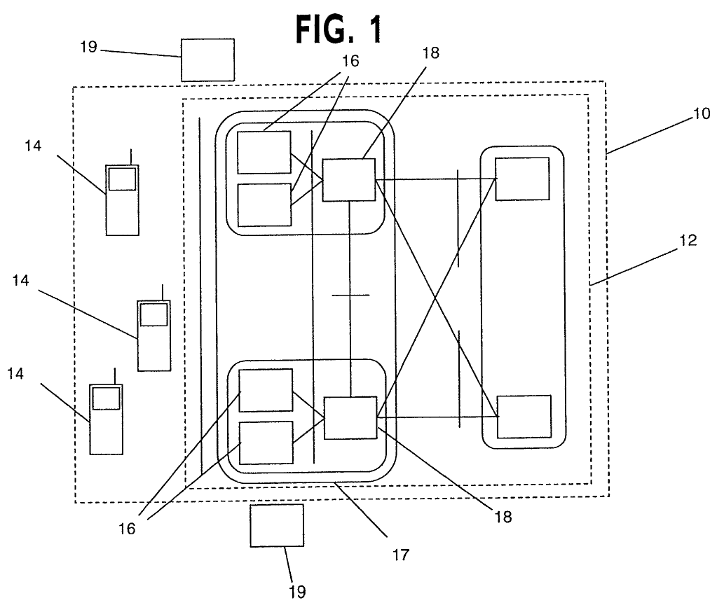

FIG. 1 shows a WCDMA system according to the invention;

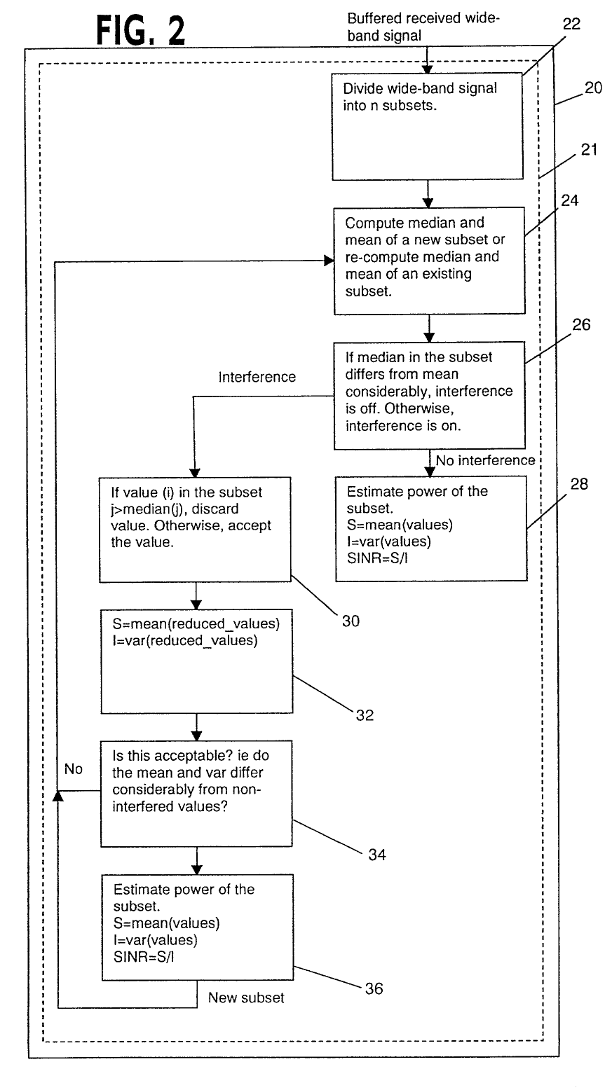

FIG. 2 shows a flowchart showing a method according to the invention;

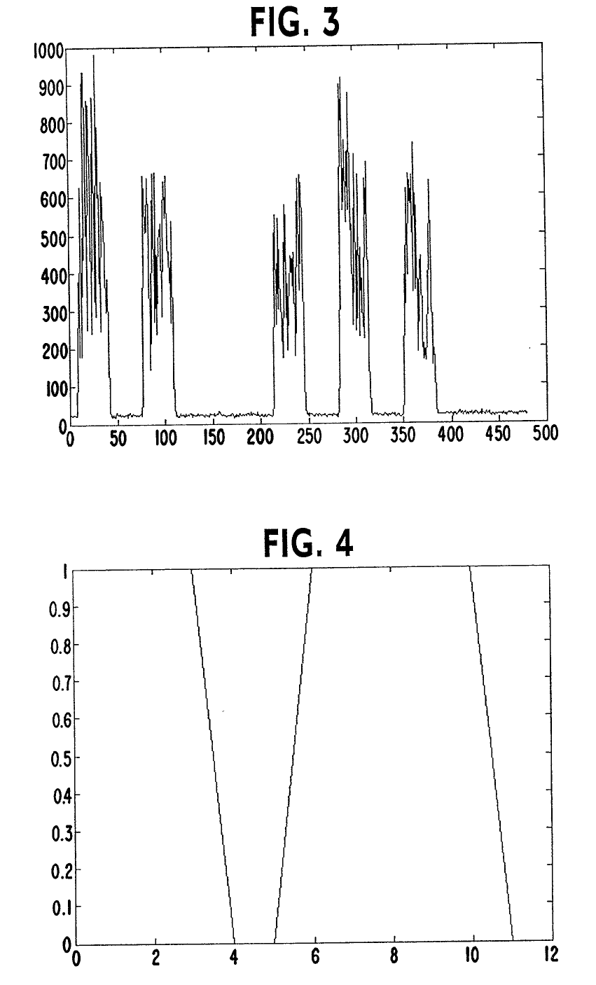

FIG. 3 shows a received wide-band signal containing interference; and

FIG. 4 shows the result of applying the invention to the signal of FIG. 3.

FIG. 1 shows a WCDMA system 10 according to the invention. FIG. 1 shows a schematic representation of various WCDMA functionalities which are useful in describing the invention. The system 10 comprises a network 12 communicating with terminals 14. The network 12 has WCDMA base transceiver stations 16 connected to an access network 17 comprising radio network controllers (RNCs) 18. In addition to the WCDMA base transceiver stations 16, GSM base stations 19 are also present as part of a GSM network which is not shown. In situations in which there is a limited number of locations in which base stations are to be located, the GSM base stations and WCDMA base transceiver stations may be located close to one another.

A WCDMA base station 16 receives a signal including data transmitted by terminals 14, noise, and interference. The noise and interference may include signals coming from other WCDMA base transceiver stations 16, terminals 14, and the GSM network. Despreading codes are used to obtain data transmitted to the network 12 according to the well-known principles of WCDMA.

In general terms, the invention operates as follows. The signal received by the network is buffered as a set of power sample values. The buffered samples are then subdivided into n different subsets. The median and mean power values for each subset are computed based on the power samples for that subset. If the median and mean values for a subset are approximately the same, the subset is considered to contain no interference (such as bursty interference caused by the GSM network) and thus to be uncorrupted. If the median value is different from the mean value by an amount greater than a predefined threshold, that subset is considered to contain interference and thus to be corrupted.

The network contains means for controlling uplink traffic, referred to as an admission control unit, and means for controlling downlink traffic, referred to as a load control unit. Both the admission control unit and the load control unit are located in the RNC. The admission control unit, given the numeral 20 in FIG. 2, will now be explained in more detail with reference to an admission control sub-unit 21. In this embodiment of the invention, the admission control sub-unit 21 is a portion of admission control that measures the power of incoming signal. Features of load control are located in the RNC and are not shown since they are well known to the skilled person. In other embodiments, the admission control unit can be located in a base transceiver station. The admission control sub-unit 21 is an auxiliary part of the admission control unit where samples having GSM interference are suppressed.

The buffered power sample values are fed into a block 22 which divides them into n subsets of power sample values. The subsets are then handled individually.

A first subset is fed to block 24 which computes its mean and median values. Block 26 then checks whether the median value of the subset differs considerably from the mean value.

If there is no considerable difference between the median value and the mean value, it is assumed that there is no interference, and block 28 calculates the variance value of the subset and the estimated signal power S of the subset is set to be equal to the mean value, the interference level I is set to be equal to the variance value, and the SINR (or signal-to-interference+noise ratio) is calculated as S/I.

If there is a considerable difference between the median value and the mean value, it is assumed that there is interference, and block 30 takes each power sample value from the subset and discards those power sample values which exceed the median value and retains those power sample values which do not exceed the median value to provide a reduced (adjusted) set of power sample values. In an alternative embodiment, the power sample values which exceed the median value are clipped rather than discarded to provide an adjusted set of samples. Such a clipping operation may involve replacing the original values by the median or mean values of the subset. In block 32, a new mean value and a variance value are calculated based on the resulting subset. The new mean value calculated in block 32 replaces the mean value calculated earlier in block 24. The estimated signal power S of the subset is set to be equal to the new mean value and the interference level I is set to be equal to the variance value,

In block 34, the new mean value and the variance value are then compared with threshold mean and variance values. These may be artificial values representing interference-free subsets, values from subsets considered not to contain any interference, or statistically based values calculated from the subset being examined, for examples values based on Rayleigh fading in the subset. If there is no considerable difference between the respective mean and variance values, in block 36 the mean and variance values calculated in block 34 are used and the estimated signal power S of the subset is set to be equal to the mean value. SINR (or signal-to-interference ratio) is calculated as S/I.

If there is a considerable difference between the respective mean and variance values, the values of the subset resulting from block 32 are fed back to block 24 and the subset is operated on in a way similar to that described above. This feeding back may occur as many times as possible until acceptable values of mean and variance are obtained from block 34, Adoption of such a turbo principle is intended to provide a more accurate estimate of signal power and interference. In an embodiment of the invention in which samples are discarded, the number of loops must be limited, In an embodiment in which samples are replaced, the number of loops must be limited so as not to compromise the operation of the WCDMA system.

At this point, the first subset has been processed, Subsequently, the sub-unit processes the following subsets until all of the subsets of the buffered received wide-band signal have been processed.

The admission control unit uses the following algorithm A to detect corrupted subsets:

```
for i = 1:Number_of_subsets
  if(abs(median(i) − mean(i) )>Threshold)
    Interference is present
  else
    Interference is not present
  end
end
```

Therefore, algorithm A discriminates between corrupted subsets for which the computed mean and median values are sufficiently close and uncorrupted subsets for which the computed mean and median values are sufficiently different.

In an embodiment of the invention in which the power sample values are discarded rather than replaced by clipped values, the following algorithm B operates in conjunction with the algorithm A above:

```
for j=1:Number_of_subsets
if (Interference is not present)
  Signal_power = mean(values_of_the_subset)
else
  for p=1:Samples_in_the_subset
    if(value(p) > median(j))
      neglect the value(p)
    else
      accept the value(p)
    end
  end
  Signal_power = mean(values_of_the_reduced_subset)
end
end
```

Although the invention has been described in which subsets contain 40 samples, in another embodiment of the invention, this number is not fixed. In such an embodiment, the number of samples to be present in each group of subsets which is dealt with at one time (for example for all of the samples contained in the buffer) can be calculated from each group of subsets. For example, a first subset of 40 samples is examined using algorithm A and, if there is no interference, another subset of 40 samples is examined. If there is again no interference, a third subset of 40 samples is examined. If there is interference, it is determined that the subset will be 80 samples long (that is the number of samples which was examined without finding interference). There are several alternatives to do the subset length definition. The subset length can be fixed (as in example shown in this application, 40 samples in each subset) or dynamic (the subset length can be varied when necessary).

Once estimates of signal power and interference have been obtained for all of the subsets, general signal power and interference estimates are available to update the estimates which are used in load (admission) control.

The effect of the invention will now be demonstrated by showing an example of its operation. FIG. 3 shows an example of power sample values of a signal received by the WCDMA network 12 of FIG. 1. The power sample values contain data, noise and interference caused by the GSM system. As can be seen from FIG. 3, GSM bursts can clearly be seen as interference extending far above the typical signal and noise level. In this embodiment, 480 samples are subdivided into 12 different subsets (that is n=12). Each subset is 40 samples long, which is greater than the length of a GSM burst. In a preferred embodiment of the invention, in the time domain, the length of a subset is chosen to be longer than the length of a GSM burst. This ensures that the subset includes some values of the desired signal which do not overlap in time with the GSM burst so that it can be seen that the median deviates from the mean. If the length of the subset is shorter than the GSM burst, the median and mean can be very close to each other, which can result in interference not being detected even though it is present. By choosing a suitably long subset, at least some of the samples fall outside of the time duration of the interference and so are uncorrupted.

The algorithm A was applied to the received signal of FIG. 3 to produce a result which is shown in FIG. 4. The x-axis is subset number and, as mentioned above, each subset represents 40 samples so that from 0 to 1 is samples 0 to 40, from 1 to 2 is samples 40 to 80, et cetera. As a result of applying the algorithm A, a determination is made whether a subset is corrupted (value=1) or uncorrupted (value=0). Therefore, in this specific case only subsets 5 and 12 are uncorrupted. In the algorithm A used in this embodiment of the invention, the value of Threshold was set to 2.

Some examples will now be given showing the effect of applying the invention to the set of power values of received signal samples of FIG. 3. When taken directly from FIG. 3, the power sample values have the following statistics of:

1) Variance:

| | Subset | | | | | | | | | | | |
|---|---|---|---|---|---|---|---|---|---|---|---|---|
| | 1 | 2 | 3 | 4 | 5 | 6 | 7 | 8 | 9 | 10 | 11 | 12 |
| Variance | 8.703* | 2.3203* | 5.4087* | 0.0010* | 0.0011* | 4.1681* | 3.0116* | 7.7366*10⁴ | 4.9643*10⁴ | 4.3258*10⁴ | 0.0011*10⁴ | 0.0006*10⁴ |
| | 10⁴ | 10⁴ | 10⁴ | 10⁴ | 10⁴ | 10⁴ | 10⁴ | | | | | |

2) Mean:

| | Subset | | | | | | | | | | | |
|---|---|---|---|---|---|---|---|---|---|---|---|---|
| | 1 | 2 | 3 | 4 | 5 | 6 | 7 | 8 | 9 | 10 | 11 | 12 |
| Mean | 426.255 | 72.6370 | 334.550 | 24.106 | 29.0342 | 260.736 | 88.0355 | 425.833 | 136.178 | 210.441 | 23.446 | 21.461 |

As can be seen, GSM interference corrupts the variance values for subsets 1 to 3 and 6 to 10 leading to very high values. The mean values for these subsets are also very high for the same reason. Thus it is very hard to define the correct value of the received power

Following application of the invention, the power sample values have the following statistics of:

1) Variance:

| | Subset | | | | | | | | | | | |
|---|---|---|---|---|---|---|---|---|---|---|---|---|
| | 1 | 2 | 3 | 4 | 5 | 6 | 7 | 8 | 9 | 10 | 11 | 12 |
| Variance | 8.5560 | 8.5560 | 8.5560 | 10.043 | 10.558 | 10.558 | 10.558 | 10.558 | 10.558 | 10.558 | 11.306 | 6.275 |

In this example, the correct variance value is around 10. Therefore, it can be seen that the invention may sometimes lead to an underestimation in variance. This is because samples having a value greater than the mean are discarded. However, even though this affects the result, applying the invention leads to variance values which are much closer to the correct values.

2) Mean;

| | Subset | | | | | | | | | | | |
|---|---|---|---|---|---|---|---|---|---|---|---|---|
| | 1 | 2 | 3 | 4 | 5 | 6 | 7 | 8 | 9 | 10 | 11 | 12 |
| Mean | 24.616 | 24.616 | 24.616 | 24.106 | 23.034 | 23.034 | 23.034 | 23.034 | 23.034 | 23.034 | 23.447 | 21.462 |

Therefore, applying the invention leads to mean values which are much closer to the correct values.

The invention takes advantage of the fact that, whenever the power of the received signal has a Chi square distribution (that is, it has a Rayleigh envelope), the mean and median values are relatively close to each other. However, for cases in which a relatively small number of the power samples within the window of received signal power samples from which the mean and median values are derived are relatively high interference peaks (for example in the case of GSM interference), the mean value tends to increase at a proportionally greater rate than the median value. This can be appreciated by considering how the mean and the median values are affected. In the case of the equation used to calculate the mean value ^{\overline{x}}:

$$\overline{x} = \frac{{\sum }_{i = 0}^{N} {x}_{i}}{N} , \qquad ( 2 )$$

where N is the number of samples and ^{x}^{ᵢ} is the sample value, the mean value increases due to the relatively high interference values being included in the nominator, whilst the number of samples, that is the denominator, remains the same. Of course, this only applies if the strengths of the interference peaks are high enough. In the case of the median, if there is relatively small number of interference peaks, it increases at a relatively lower rate, since it divides the samples into a group greater than the median and a group lesser than the median. Now if the group greater than the median is relatively small compared to the total number of samples, the median value increases at a lower rate than the mean value.

Since the invention enables corrupted subsets to be corrected (by removing or replacing bad samples), a better estimate of variance, and thus of noise level, can be determined. Consequently, in communication systems in which the invention is applied better load (admission) control is possible during periods of GSM interference.

In the foregoing, an embodiment of the invention has been described in which load/admission control is carried out by the network. Therefore, the foregoing is consistent with the invention being applied to an UMTS system because in such a system terminals are not standardised to carry out load/admission control. (However, it should be noted that the terminal does carry out some auxiliary measurements (such as measurement of interference from surrounding base stations) which are sent to the network where the actual load/admission control is done.) In another embodiment of the invention, the functionality of the invention is incorporated into terminals so that they carry out load/admission control. This embodiment applies to terminals be present in an UMTS system or in other systems. Therefore, although the invention has been described in terms of apparatus which is present within the network, in another embodiment, the invention can be implemented in terminals or in both the network and in terminals.

Particular implementations and embodiments of the invention have been described. It is clear to a person skilled in the art that the invention is not restricted to details of the embodiments presented above, but that it can be implemented in other embodiments using equivalent means without deviating from the characteristics of the invention. The scope of the invention is only restricted by the attached patent claims.

1. A method of operating a communications system comprising:
receiving a signal transmitted by the communications system;
processing the signal based on the assumption that it has a particular statistical distribution; and
removing parts of the signal which do not correspond to the particular statistical distribution.

2. A method according to claim 1 which comprises estimating signal power.

3. A method according to claim 1 which comprises estimating noise and/or interference power level.

4. A method according to claim 1 in which the assumption is that the signal has a Gaussian statistical distribution.

5. A method according to claim 1 which comprises dividing the signal into subsets comprising sets of sample values.

6. A method according to claim 5 which comprises assessing the subsets to determine if they are corrupted, that is if they contain more than a predetermined level of interference.

7. A method according to claim 6 which comprises calculating a first statistical characteristic and a second statistical characteristic of the at least one subset.

8. A method according to claim 7 which comprises calculating the mean of the set of sample values for at least one subset.

9. A method according to claim 7 which comprises calculating the median of the set of samples for at least one subset.

10. A method according to claim 7 in which the predetermined level of interference is set by indicating as uncorrupted those subsets having a difference between the first and second statistical characteristics of the subset in the subset which is less than a predetermined or threshold value.

11. A method according to claim 7 which comprises, for a subset assessed as being corrupted, removing one or more of the sample values from the subset.

12. A method according to claim 11 in which the removed sample values are those which have values exceeding a median value of the sample values of the subset.

13. A method according to claim 11 in which removed sample values are replaced with other sample values.

14. A method according to claim 7 which comprises, for a subset assessed as being corrupted, clipping one or more of the sample values from the subset to a statistically defined value.

15. A method according to claim 7 in which, following calculation of the first and second statistical characteristics of a subset to carry out a first assessment of whether the subset is corrupted, samples are removed, clipped, and/or replaced, and then the first and second statistical characteristics of the subset are recalculated to carry out a second assessment of whether the subset is corrupted.

16. A method according to claim 5 in which the length of a subset is longer in the time domain than the length of interference bursts so as to include into the subset sample values which are not suffering interference.

17. A method according to claim 1 which comprises load control.

18. A method according to claim 1 which comprises admission control.

19. A method according to claim 1 which comprises reducing interference caused by another communications system.

20. A method according to claim 1 which comprises removing discontinuous interference caused by another communications system.

21. A method according to claim 1 which comprises reducing interference caused by a TDMA communications system.

22. A method according to claim 1 which comprises removing interference caused by a GSM communications system.

23. A method according to claim 1 which comprises removing interference in a wireless communications system.

24. A method according to claim 1 which comprises removing interference in a spread-spectrum communications system.

25. In a communications system, a network element comprising:
means for receiving a signal transmitted by a communications system;
means for processing the signal based on the assumption that it has a particular statistical distribution; and
means for removing parts of the signal which do not correspond to the particular statistical distribution.

26. A network element according to claim 25 which is selected from a group consisting of: a admission control unit, a load control unit, a radio network controller (RNC), a node B, a base station, and a base transceiver station.

27. A communications system comprising:
means for receiving a signal transmitted by the communications system;
means for processing the signal based on the assumption that it has a particular statistical distribution; and
means for removing parts of the signal which do not correspond to the particular statistical distribution.

28. A communications system according to claim 27 which is selected from a group consisting of: a spread-spectrum system, a CDMA system, and a WCDMA system.

29. In a communications system, a communications terminal comprising:
means for receiving a signal transmitted by the communications system;
means for processing the signal based on the assumption that it has a particular statistical distribution; and
means for removing parts of the signal which do not correspond to the particular statistical distribution.

30. A communications terminal according to claim 29 which is selected from a group consisting of a spread-spectrum terminal, a CDMA terminal, and a WCDMA terminal.

31. A method of controlling a communications system comprising:
receiving a signal transmitted by the communications system having a set of sample values;
calculating a first statistical characteristic and a second statistical characteristic of the set of sample values;
determining whether the set of sample values has a Gaussian distribution by checking a difference between the first and second statistical characteristics against a predetermined or threshold value;
if the set of sample values does not have a Gaussian distribution, considering it as being corrupted and adjusting sample values in the set in order to provide an adjusted set of sample values;
calculating the first statistical characteristic and the second statistical characteristic of the adjusted set of sample values;
determining whether the adjusted set of sample values has a Gaussian distribution by checking a difference between the first and second statistical characteristics of the adjusted set of sample values against the predetermined or threshold value.
